(19) United States
(12) Patent Application Publication
(10) Pub. No.: US 2003/0101135 A1
(43) Pub. Date: May 29, 2003

(54) Real-time reservation of charges for pre-paid services

(76) Inventors: Mark Myatt, Brisbane (AU); Felim O'Neill, Galway (IE); Malcolm Crouch, Toronto (CA); Michael Jenvey, Brisbane (AU); Grahm Agnew, Brisbane (AU); Michael Rosenberg, Brisbane (AU)

Correspondence Address: SCHWEGMAN, LUNDBERG, WOESSNER & KLUTH, P.A., P.O. BOX 2938, MINNEAPOLIS, MN, 55402, US

(21) Appl. No.: 09/960,261

(22) Filed: Sep. 20, 2001

(51) Int. Cl. G06F 17/60

(52) U.S. Cl. 705/40

(57) ABSTRACT

A computerized system includes a rating engine and a balance manager. The balance manager maintains a database having accounts, where the accounts have an account balance. The balance manager is operative to receive event data, calculate a reservation amount based on the event data, determine a service unit quantity based on the reservation amount, and reserve the reservation amount against the pre-paid account.

### FIELD

The present invention relates generally to computerized systems for maintaining pre-paid service, and more particularly to reserving charges against pre-paid services.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright® 2001, ADC Telecommunications Inc. All Rights Reserved.

### BACKGROUND

Mobile network services continue to evolve at a rapid pace. With each new generation, more services and features are incorporated in mobile devices such as cellular phones and wireless computing devices. There is a continuing trend towards a convergence of Internet, mobility, media and broadband features in these mobile devices. As an example, the current generation of mobile devices, referred to as 3G (third generation) mobile devices, are capable of providing voice services, text messaging services, Internet networking services, and multimedia content services.

In the past, these services have been provided on a post-paid basis, or by dedicated pre-paid systems that were required for each category of service. For post paid services, as services are provided for a particular customer account, billing event data is collected regarding the service provided and stored in a database accessible to a computerized billing system. Periodically (typically monthly), a bill is sent to the customer that details the charges against the account for the services provided during the billing period. The services are thus post-paid because payment is made after the service is provided.

There has been rapid growth of pre-paid services. In pre-paid service environments, customers make payments up-front, that is, prior to the rendering of the service. As services are provided, the charges for the service are deducted from the account. If the account balance falls to zero, services are no longer provided until additional funds are added to the account. Pre-paid services provide advantages to both the customer and the service provider. The customer knows in advance the maximum they will be charged for service, because the charges will typically not exceed the pre-paid amount placed in the account. This is unlike post-paid service, where the charges against the customer's account are not known until the bill is received. Additionally, the service provider does not have to worry about the creditworthiness of the customer. Because amounts are pre-paid, the service provider is assured they will be compensated for the services provided.

However, there are several problems associated with pre-paid services. A first problem relates to services that are charged based on the duration or other metric associated with an event. For example, it is rarely the case that a user will know in advance how long a phone call will last, or how many bytes of data will be transferred during a data session. As a result, it is not possible to calculate a charge until the event is over. This results in the possibility that a user will incur a charge that is greater than the amount available in their pre-paid account. In order to guard against this possibility, previous systems, at the initiation of an event, have reserved the entire amount available in the account rather than waiting to calculate the charge at the end of the event.

A second problem relates to the fact that multiple users can be using services on multiple mobile devices associated with the same account. If the entire amount in the account is dedicated to a first user of the account, no other users can use services until the first user is done. For example, if a user A is using a mobile phone to make a phone call while user B is attempting to establish a wireless network session on a portable PC, user B will be denied service until user A completes their phone call.

A further problem is related to the multi-service nature of 3G systems. Traditionally, pre-paid services run on intelligent network (IN) servers. However, the 3G system can also concurrently use services provided by content servers and m-commerce (mobile commerce) servers. As a result, a more centralized account balance management model is required than has been provided in previous systems.

In view of the above-described problems, there is a need in the art for the present invention.

### SUMMARY

The above-mentioned shortcomings, disadvantages and problems are addressed by the present invention, which will be understood by reading and studying the following specification.

In one embodiment, a computerized method for reserving an amount against a pre-paid account includes receiving event data; calculating a reservation amount based on the event data; determining a service unit quantity based on the reservation amount; and reserving the reservation amount against the pre-paid account.

In a further embodiment, a computerized system includes a rating engine and a balance manager. The balance manager maintains a database having accounts, where the accounts have an account balance. In one embodiment, the balance manager is operative to receive event data, calculate a reservation amount based on the event data, determine a service unit quantity based on the reservation amount, and reserve the reservation amount against the pre-paid account.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram an operating environment in which different embodiments of the invention may be practiced;

FIG. 2 is a flow diagram illustrating a method for reserving amounts against pre-paid services according to an exemplary embodiment of the invention; and

FIG. 3 is a flow diagram illustrating a method for determining a reservation amount according to an exemplary embodiment of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description.

The detailed description is divided into three sections. In the first section the operating environment of different embodiments of the invention is described. In the second section, the methods according to varying embodiments of the invention are described. In the final section, a conclusion is provided.

### Operating Environment

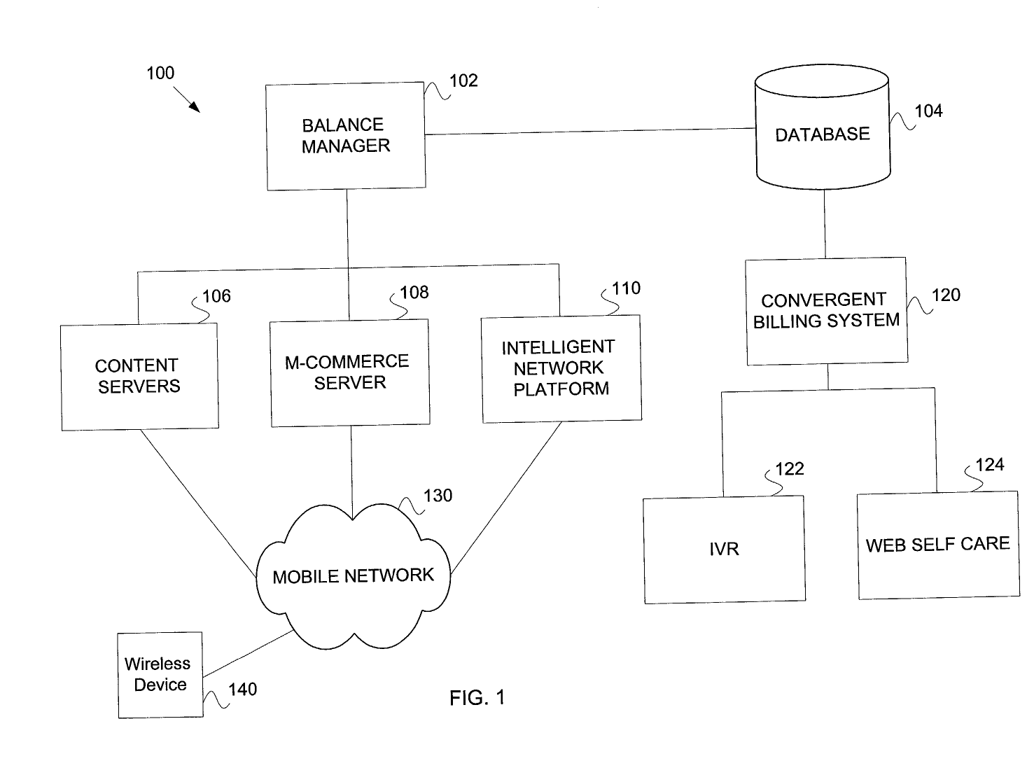

FIG. 1 illustrates an operating environment 100 in which embodiments of the invention may be practiced. As shown, environment 100 includes a balance manager 102 communicably coupled via a network to zero or more content servers 106 zero or more m-commerce servers 108, and zero or more intelligent network platforms 110. Content servers 106 m-commerce servers 108 and intelligent network platforms 110 are also communicably coupled to mobile network 130. In one embodiment of the invention, mobile network 130 is a wireless network that provides the ability to communicably couple a variety of wireless devices 140 with one another and with servers on the network 130. An example of such a network supports the GSM (Global System for Mobile Communications) standard. However, the invention is not limited to GSM type networks, and other wireless communications networks are within the scope of the invention. Examples of wireless devices include cellular phones, personal digital assistants (PDAs), and portable computers with wireless network interfaces.

Intelligent Network (IN) platform 110 comprises a computerized system capable of controlling and managing voice and data transport services on network 130. In addition to basic services such as managing voice and data connections, IN platform 110 can also provide services such as voice mail, e-mail notification, fax notification and paging. In one embodiment of the invention, IN platform 110 is a CAMEL3 (Customized Application of Mobile Enhanced Logic) platform.

An M-commerce server 108 comprises a server capable of supporting “m-commerce”, that is mobile commerce. Mobile commerce is a general term used to describe the buying and selling experience on the mobile network 130. M-commerce typically requires real-time authorization for purchases of goods and services made available through m-commerce server 108. The payment itself can be made in a number of ways, e.g. directly keying in a credit-card or debit card number and expiry date, by debiting an account associated with the user's wireless device 140.

A content server 106 comprises a server that provides video, audio, text based, and multi-media data that can be downloaded by devices on a network, including a wireless device 140. Often there is a charge associated with the downloading such content. For example, a user may be required to pay a subscription fee to access data on content server 106. Alternatively, the user may be charged a fee for each download of a content data file.

In addition to, or instead of the charging described above, each of the servers 106, 108 and 110 may calculate a charge based on service units. A service unit is a metric used to measure the quantity of a service being used. For example, the metric for a voice call or data connection may be duration based. In this case, the service unit is typically a quantity of time such as a second, minute, hour etc. Alternatively, the service unit for a data connection or download may be the number of bytes transmitted and/or received. Other examples of service units include tokens and messages. The invention is not limited to any particular type of service unit.

Balance manager 102 is a computerized system operable to provide account balance management and rating services. In one embodiment of the invention, balance manager 102 receives requests to authorize and apply charges against pre-paid services. Examples of such charges include charges incurred as a result of downloading content from content servers 106, purchasing goods and/or services through an m-commerce server 108, and connection and airtime charges for voice and data connections controlled by IN platform 110. In general, balance manager 102 receives requests to authorize charges against an account associated with a wireless device. In the case of some content and goods or services, the charge may be known up-front and authorization is a relatively simple matter of comparing the charge amount with the pre-paid balance for the account associated with the wireless device. However, in the case of content and other downloads that may have connection and airtime charges, the charged amount cannot be determined up-front, because the number of service units required for a particular event is not known until the event has terminated. In order to handle such cases, the balance manager 102 determines whether the event should be authorized. In addition, in some embodiments, the balance manager determines a number of service units to authorize and reserves a corresponding amount against the account. The reservation can be committed if the event completes successfully. Alternatively, the reservation can be cancelled if the event does not complete successfully. Furthermore, the reservation can expire if the event does not complete within a predetermined amount of time. Further details on the reservation process are provided in the next section.

Balance manager 102 is operably coupled to database 104. Database 104 maintains account information including an account identifier used to associate the account with one or more wireless devices and account balance information. Database 104 can be any type of database system known in the art, the invention is not limited to any particular database management system.

Convergent billing system 120 is also operably coupled to database 104. Convergent billing system uses the data in database 104 to provide billing data to customer and employees of the network provider. Billing system 120 can provide the data using an interactive voice response system (IVR)122 or through a web-based “self-care” system 124.

### Methods

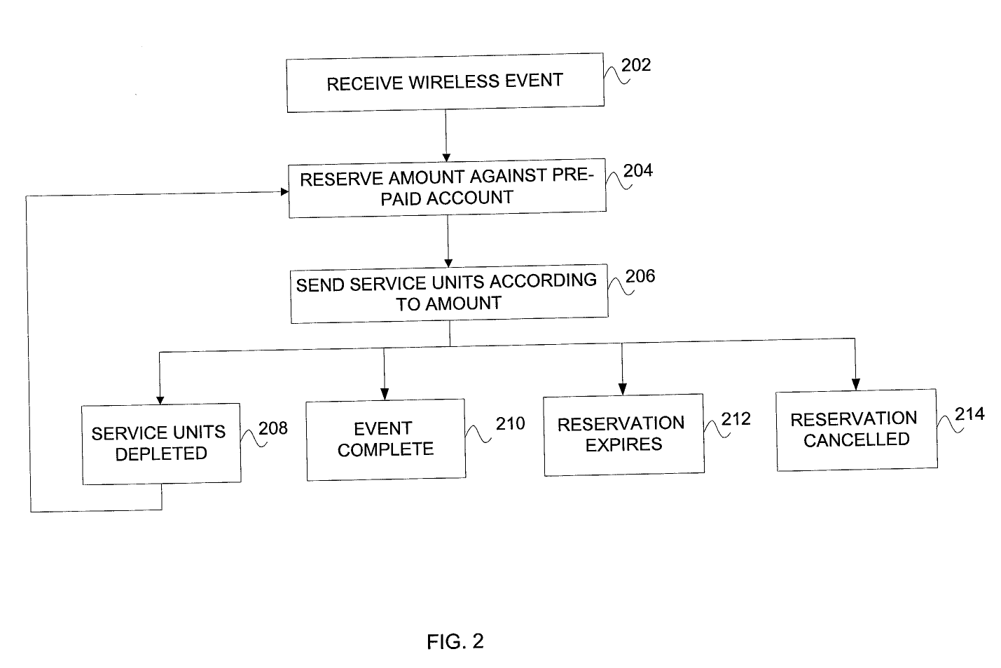

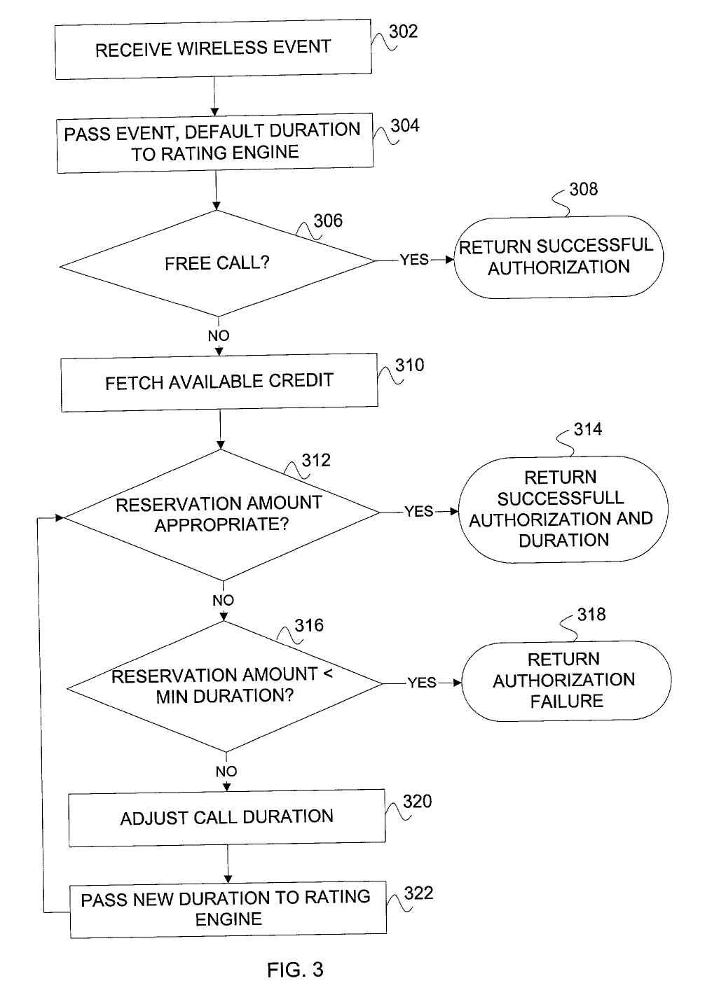

In this section, the particular methods executed by an exemplary embodiment are described by reference to a series of flowcharts shown in FIGS. 2-3. The methods to be performed by the operating environment constitute computer programs made up of computer-executable instructions. Generally such computer-executable instructions are loaded from a computer-readable medium such as a ROM, hard drive, floppy drive, CD-ROM, DVD-ROM, Flash Memory or other device capable of persistently storing the instruction. The instructions are typically loaded into a computer-readable medium such as RAM for execution.

Describing the methods by reference to a flowchart enables one skilled in the art to develop such programs including such instructions to carry out the methods on suitable computers (the processor of the computer executing the instructions from computer-readable media). The methods illustrated in FIGS. 2-3 are inclusive of the acts required to be taken by an operating environment executing an exemplary embodiment of the invention.

FIGS. 2-3 describe a process for reserving an amount against a pre-paid service, and a process for determining an appropriate amount to reserve that is referred to as “reverse rating.” Rating is generally a process by which a charge for an event such as a call or data connection is determined. Generally speaking, an event is rated by passing event parameters such as an event type and a quantity of service units. For example, a call event may be rated by passing call parameters such as duration and call type to a rating engine. The rating engine determines the appropriate tariff based on the type of the call (e.g. local, long distance, international) and the time that the call was placed, along with the duration of the call to determine the charge for the call. Rather than providing a charge for an event, reverse rating receives the type of event and a monetary amount and provides a corresponding quantity of service units that are authorized for the event. For example, reverse rating a wireless phone call event may include receiving a monetary amount and a call type, and providing a duration that is authorized for the call. Similarly, a reverse rating for a download event can include receiving a monetary amount and download type and providing a corresponding number of bytes that can be downloaded. Reverse rating can be applied to any type of service unit. For example, reverse rating may return a quantity of time, bytes, messages, or tokens that are authorized for use. In one embodiment of the invention, reverse rating is used to reserve amounts against a pre-paid account.

FIG. 2 is a flow diagram illustrating a method for reserving amounts against pre-paid services according to an exemplary embodiment of the invention. The method begins when a system executing the method receives a wireless event (block 202). The wireless event can signal the beginning of a voice call, a network session, a content download, a purchase event or other type of event. The invention is not limited to any particular type of event.

Next, the system executing the method reserves an amount against the pre-paid account. Typically the amount reserved will be less than the total amount available in the pre-paid account. This is desirable in order to allow multiple account users the opportunity to use the account to obtain services concurrently. Further details regarding the calculation of the reserve amount will be provided below in reference to FIG. 3. It should be noted that the reserved amount does not represent a committed charge, rather it represent an amount from the account that is not available for any other event while the reservation exists.

After the amount to reserve has been determined, the system determines the number of service units that should be authorized. In some embodiments of the invention, the service units are time units such as seconds, minutes or hours, and represent a duration for a call or data connection. The duration is calculated according to the amount reserved against the account. In addition, in some embodiments, the duration is also calculated according to the tariffs in effect for the type of call (e.g. local, long distance etc.). For example, if an amount equal to $10.00 has been reserved and the tariff is $0.20/minute, than a duration of 50 minutes will be authorized. In some embodiments, if the account does not have a minimum amount available to reserve, the event will not be authorized and the duration will be zero. In addition, the service units can represent a quantity of messages that are to be sent to and from the wireless device. As an example, if $10.00 has been reserved and there is a charge of $10.00/message, the 100 messages will be authorized. Data indicating the quantity of service units authorized is sent to the mobile device (block 206).

Blocks 208, 210, 212 and 214 represent possible alternatives that may occur after an amount has been reserved against an account and a quantity of service units authorized based on the reserved amount. Block 208 represents the depletion of the authorized service units before the event is complete. For example, a user may desire to talk on their mobile phone for a longer period of time than has been authorized. In this case, the system executing the method will receive a request to reserve a further amount against the pre-paid account and return to block 204.

Alternatively, a reservation may be cancelled (block 214). In some embodiments, cancellation of a reservation results in the reservation amount being freed and made available for other events. As an example, a reservation may be made at the start of a content download, and authorized for the whole download. If the download fails before completion, the reservation may be cancelled.

Another alternative is that the reservation may expire prior to completion of the event, or before the event begins (block 212). In some embodiments, reservations may be configured with an expiry date and/or time. The expiry date and time can be in absolute terms, or it can be in relative terms. In these embodiments, upon expiration, a reservation is cancelled and the reservation amount freed for other events. As an example, assume that a reservation may be made for a content download and, for purposes of the example, reservations are configured to expire after two hours. Further assume that due to a system failure, the download never takes place, and that the content server does not request cancellation of the reservation. In this case, the reservation expires after two hours, and the reserved amount is made available for other events.

A further alternative is that the event completes (block 210). The event may end prior to the depletion of authorized service units, or it may end when the authorized service units have been depleted. In some embodiments, the actual number of service units used may be used to calculate a charge that is committed to the pre-paid account. Any reserved amount in excess of the actual charge is cancelled. For example, assume that $10.00 has been reserved for a voice call, resulting in a service unit quantity of 20 minutes. Further assume that the call finishes after 16 minutes resulting in an actual charge of $8.00. In some embodiments, the original $10.00 reservation is cancelled and the actual charge of $8.00 will be committed against the account as a single transaction. Alternative transactions are possible, for example the original reservation amount of $10.00 can be committed along with a credit of $2.00 for the unused amount. Any amount left in the account is available for future use.

FIG. 3 is a flow diagram illustrating a method for determining a reservation amount according to an exemplary embodiment of the invention. The method described below refers to various constants shown in table 1 below. The constants shown below are configurable. Note that different sets of constants may be used for different call categories e.g. local versus long distance versus international. Additionally, in alternative embodiments of the invention, the constants can vary depending on the account.

TABLE 1

| Constant | Description |
|---|---|
| DefaultDurationToken | The initial duration to use when rating a |
| | reservation event. This value should be chosen, |
| | balancing probability that the reservation is |
| | successful versus maximizing the size of the |
| | reservation token size. In one embodiment, the |
| | constant is selected such that 80% of events |
| | terminate within the default duration. |
| | The DefaultDurationToken is generally greater |
| | than the MinDurationToken. |
| MinDurationToken | This is the minimum duration that is reserved |
| | for a voice call. If a subscriber does not have |
| | enough balance to pay for this amount of |
| | duration, then the call will not be authorized. |
| MaxNumberRateReturns | This is the maximum number of rate and return |
| | calls to the Rating Engine per reservation |
| | request. The minimum this value can be is 2. |
| CreditLowWaterMark | If the Available Credit for a subscriber is below |
| | this value, all of the available credit may be |
| | reserved for a call. |
| CreditPerCallPercentage | If the Available Credit for a subscriber is |
| | above the CreditLowWaterMark, then the |
| | maximum amount reserved for a single call is |
| | equal to Available Credit times the |
| | CreditPerCallPercentage. In some |
| | embodiments, if this value is less than |
| | the CreditLowWaterMark, then the maximum |
| | amount is the CreditLowWaterMark. |
| | For example, if this value is set to 50% and |
| | the available credit is $20 and the |
| | CreditLowWaterMark is $2, then the maximum |
| | amount reserved for a single call is $10. |
| | Note that on subsequent reservation |
| | extensions for the same call, the available |
| | credit will be lower, thereby adjusting the |
| | maximum amount available to reserve. |

The method begins when an event is received (block 302). Typically the event will be a request to authorize a charge against a pre-paid account. Data included with the event will be the type of call. However, the service and account associated with the event are typically not known at this point. Next, the event data is passed to a rating function, as well as a duration equal to DefaultDurationToken (block 304). In some embodiments, the rating function is executed by a rating engine. Rating functions are known in the art, and apply tariffs and duration data to return a charge for a given call. The rating function returns the charge for the given default duration. This charge is referred to as the reservation amount. In some embodiments, the rating algorithm also identifies the account that the call should be billed to.

Next, in some embodiments of the invention a check is made to determine if the call is a free call (decision block 306). For example, the call may be to a toll free number in which case the user is not charged for the call. If the call is a free call, the method returns a successful authorization and in addition flags the call as a free call to avoid subsequent authorization requests (block 308)

Otherwise the balance manager fetches the available credit (block 310). The available credit is determined by examining the account identified by the rating function as the account associated with the event.

Decision block 312 is the top of a loop that can iteratively adjust a reservation amount until either a successful reservation can be made, or failure is detected. In some embodiments of the invention, a counter (the Rate Return count) is maintained to insure that the loop is not executed more than MaxNumberRateReturns times. This is to ensure that the system response does not degrade due to repeated execution of the rating function.

Decision block 312 checks to determine if the current reservation amount is appropriate. In one embodiment of the invention, the condition that must be met to determine that the reservation amount is appropriate is:

( Available Credit > reservation amount ) AND

(
[Available Credit <= CreditLowWaterMark] OR
[reservation amount < Available Credit * CreditPerCallPercentage]
)

If the current reservation amount is determined to be appropriate, then the method returns an indication of a successful authorization and the authorized duration. In addition, the current reservation amount is reserved against the account.

Otherwise, previous reservation amount is too high and a new reservation amount needs to be determined. The method proceeds to determine if the current reservation amount is less than MinDurationToken, the minimum allowed reservation amount (decision block 316). If it is, there is insufficient credit in the account to make the call. In this case, the method returns a reservation failure to the requesting application (block 318).

If the reservation amount is greater than MinDurationToken, the current reservation amount is too high, but there is sufficient credit to determine a new reservation amount and duration. A new duration is calculated that is less than the previous duration (block 320). In some embodiments of the invention, the desired reservation amount is calculated based on the available credit. In one embodiment, the following algorithm is used to calculate the desired reservation amount:

IF (Available Credit × CreditPerCallPercentage <= CreditLowWaterMark)
THEN

Desired Reservation Amount = CreditLowWaterMark

ELSE

Desired Reservation Amount = AvailableCredit × CreditPerCallPercentage

Additionally, some embodiments of the invention calculate a new event duration using the following algorithm:

fCalcNewDuration(DesiredAmount#, RatedCharge#, Duration#)
{

# Set the duration to be 60% of the duration for the linear rate.
Return 0.6 * DesiredAmount# / RatedCharge# * Duration#;

}

Where f(Desired Reservation Amount, Rated Charge, Duration) is a configurable function that returns the new duration based on the desired reservation amount, rated charge and duration. It is desirable that this function be configured such that the resultant duration is less than the duration assuming a linear per minute tariff rate. For example, if the desired reservation amount is $10, the previous reservation amount is $20 and the duration is 5 minutes, the function should return a new duration of 2.5 minutes or less.

An example function fCalcNewDuration that calculates this value is:

IF (Rate Return Count == MaxNumberRateReturns + 1)
THEN

New Duration = MinDurationToken

ELSE

New Duration = f(Desired Reservation Amount, Rated Charge, Duration)

The rating function or rating engine is then called with the new duration to determine a new reservation amount. In addition, in those embodiments maintaining a loop counter, Rate Return Count is incremented.

The method then returns to decision block 312 to re-execute the loop with the newly calculated reservation amount and duration.

As can be seen from the above, the method is designed to produce a reservation and call duration such that the reservation amount that is within the available credit in the user's account and the duration is long enough to be practical for a call or data connection. The method attempts to provide a reasonable balance of the following competing goals:

Maximize the size of reservations, thereby minimizing the volume of reservation extensions.

Minimize the number of times the rating function is called per reservation. Each call to the rating function can be costly in terms of performance.

Minimize the overall complexity of the algorithm. The greater the complexity, the greater the processing overhead.

Avoid coupling between the balance management processing and the rating tariffs. Ideally, the tariffs should not need to do any special processing for reservations; they should simply calculate charges for events.

It should be noted that in the discussion above, the event has been described in terms of a phone call and the service units have been expressed as a duration. However, the invention is not limited to any particular form wireless event or service unit. In alternative embodiments, the method described above and in FIG. 3 is applied to events other than phone calls and service units other than duration. For example, the event can be a content download and the service units can be tokens, messages, and byte quantities.

### CONCLUSION

Systems and methods for performing reverse rating and for determining a reservation amount to apply against a pre-paid service account are disclosed. The embodiments of the invention provide advantages over previous systems. For example, the systems and methods of the present invention provide a mechanism to determine an appropriate reservation amount that does not result complete exhaustion of the user's pre-paid account, thereby leaving credit in the account to use for other services that may be concurrently accessed. For example, a user with a pre-paid account that desires to make voice calls while simultaneously accessing a content server can do so without worrying that the entire pre-paid account will be allocated to one service thereby resulting in the denial of the other service. Additionally, multiple users of a plurality of wireless devices associated with the same pre-paid account can access the account concurrently without fear that one user will allocate the entire account resulting in the denial of service to the other user of the pre-paid account.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A computerized method for reserving an amount against a pre-paid account, the method comprising:
receiving event data;
calculating a reservation amount based on the event data;
determining a service unit quantity based on the reservation amount; and
reserving the reservation amount against the pre-paid account.

2. The computerized method of claim 1, further comprising sending the service unit quantity to a device generating the event data.

3. The computerized method of claim 1, further comprising:
receiving an event corresponding to the depletion of the service unit quantity;
calculating a second reservation amount;
determining a second service unit quantity based on the second reservation amount; and
reserving the second reservation amount against the pre-paid account.

4. The computerized method of claim 1, wherein the service unit quantity comprises a time duration.

5. The computerized method of claim 1, wherein the service unit quantity comprises a storage unit quantity.

6. The computerized method of claim 1, wherein the service unit quantity comprises a message quantity.

7. The computerized method of claim 1, wherein the service unit quantity comprises a token quantity.

8. A computerized method determining a reservation amount comprising:
receiving a wireless event;
calculating a reservation amount based on a duration initially set to a default service unit quantity;
fetching the available credit in a pre-paid account;
comparing the reservation amount with the available credit; and
if the reservation amount is less than the available credit, then authorizing the event for the default service unit quantity;
otherwise performing the task of:
adjusting the service unit quantity,
recalculating the reservation amount based on the adjusted service unit quantity.

9. The computerized method of claim 8, further comprising:
comparing the service unit quantity to a minimum service unit quantity; and
sending an authorization failure if the service unit quantity is less than the minimum service unit quantity.

10. The computerized method of claim 8, wherein adjusting the service unit quantity comprises multiplying the previously calculated service unit quantity by a pre-determined percentage.

11. The computerized method of claim 8, further comprising:
determining if the event is a free event; and
returning a successful authorization prior to comparing the reservation amount with the available credit.

12. The computerized method of claim 8, wherein comparing the reservation amount with the available credit comprises satisfying the condition expressed as:
( Available Credit > reservation amount ) AND
(
[Available Credit <= CreditLowWaterMark] OR
[reservation amount < Available Credit * CreditPerCallPercentage]
)

13. The computerized method of claim 8, wherein adjusting the service unit quantity includes determining a new reservation amount according to the formula:
IF (available credit × CreditPerCallPercentage <= CreditLowWaterMark)
THEN
new reservation amount = CreditLowWaterMark
ELSE
new reservation amount = availablecredit × CreditPerCallPercentage.

14. The computerized method of claim 8, wherein determining a second service unit quantity comprises setting the second service unit quantity to the minimum service unit quantity if a rating algorithm counter exceeds a pre-determined count.

15. The computerized method of claim 8, wherein the reservation amount is determined by a rating engine that receives the service unit quantity and applies a tariff to the service unit quantity.

16. The computerized method of claim 8, wherein the service unit quantity comprises a time duration.

17. The computerized method of claim 8, wherein the service unit quantity comprises a storage unit quantity.

18. The computerized method of claim 8, wherein the service unit quantity comprises a message quantity.

19. The computerized method of claim 8, wherein the service unit quantity comprises a token quantity.

20. A machine-readable medium having machine executable instructions for performing a method for reserving an amount against a pre-paid account, the method comprising:
receiving event data;
calculating a reservation amount based on the event data;
determining a service unit quantity based on the reservation amount; and
reserving the reservation amount against the pre-paid account.

21. The machine-readable medium of claim 20, wherein the method further comprises sending the service unit quantity to a device generating the event data.

22. The machine-readable medium of claim 20, wherein the method further comprises:
receiving an event corresponding to the depletion of the service unit quantity;
calculating a second reservation amount;
determining a second service unit quantity based on the second reservation amount; and
reserving the second reservation amount against the pre-paid account.

23. The machine-readable medium of claim 20, wherein the service unit quantity comprises a time duration.

24. The machine-readable medium of claim 20, wherein the service unit quantity comprises a storage unit quantity.

25. The machine-readable medium of claim 20, wherein the service unit quantity comprises a message quantity.

26. The machine-readable medium of claim 20, wherein the service unit quantity comprises a token quantity.

27. A machine-readable medium having machine-executable instructions for performing a method for determining a reservation amount, the method comprising:
receiving a wireless event;
calculating a reservation amount based on a duration initially set to a default service unit quantity;
fetching the available credit in a pre-paid account;
comparing the reservation amount with the available credit; and
if the reservation amount is less than the available credit, then authorizing the event for the default service unit quantity;
otherwise performing the task of:
adjusting the service unit quantity,
recalculating the reservation amount based on the adjusted service unit quantity.

28. The machine-readable medium of claim 27, wherein the method further comprises:
comparing the service unit quantity to a minimum service unit quantity; and
sending an authorization failure if the service unit quantity is less than the minimum service unit quantity.

29. The machine-readable medium of claim 27, wherein adjusting the service unit quantity comprises multiplying the previously calculated service unit quantity by a pre-determined percentage.

30. The machine-readable medium of claim 27, wherein the method further comprises:
determining if the event is a free event; and
returning a successful authorization prior to comparing the reservation amount with the available credit.

31. The machine-readable medium of claim 27, wherein comparing the reservation amount with the available credit comprises satisfying the condition expressed as:
( Available Credit > reservation amount ) AND
(
[Available Credit <= CreditLowWaterMark] OR
[reservation amount < Available Credit * CreditPerCallPercentage]
)

32. The machine-readable medium of claim 27, wherein adjusting the service unit quantity includes determining a new reservation amount according to the formula:
IF (available credit × CreditPerCallPercentage < CreditLowWaterMark)
THEN
new reservation amount = CreditLowWaterMark
ELSE
new reservation amount = availablecredit × CreditPerCallPercentage.

33. The machine-readable medium of claim 27, wherein determining a second service unit quantity comprises setting the second service unit quantity to the minimum service unit quantity if a rating algorithm counter exceeds a pre-determined count.

34. The machine-readable medium of claim 27, wherein the reservation amount is determined by a rating engine that receives the service unit quantity and applies a tariff to the service unit quantity.

35. The machine-readable medium of claim 27, wherein the service unit quantity comprises a time duration.

36. The machine-readable medium of claim 27, wherein the service unit quantity comprises a storage unit quantity.

37. The machine-readable medium of claim 27, wherein the service unit quantity comprises a message quantity.

38. The machine-readable medium of claim 27, wherein the service unit quantity comprises a token quantity.

39. A computerized system comprising:
a rating engine; and
a balance manager operative to maintain a database having accounts, said accounts having an account balance;
wherein the balance manager is operative to perform the tasks of:
receive event data;
calculate a reservation amount based on the event data;
determine a service unit quantity based on the reservation amount; and
reserve the reservation amount against the pre-paid account.
